(19) United States
(12) Patent Application Publication
(10) Pub. No.: US 2025/0227421 A1
(43) Pub. Date: Jul. 10, 2025

(54) EAR-WORN DEVICES WITH REMOTE PAIRING TO OTHER EAR-WORN DEVICES

(71) Applicant: Chromatic Inc., New York, NY (US)

(72) Inventors: Nicholas Morris, Brooklyn, NY (US); Davide Asnaghi, New York, NY (US); Leo Khazan, Brooklyn, NY (US); Andrew Casper, Eau Claire, WI (US)

(21) Appl. No.: 19/015,099

(22) Filed: Jan. 9, 2025

Related U.S. Application Data
(60) Provisional application No. 63/618,936, filed on Jan. 9, 2024.

(51) Int. Cl. H04R 25/00; G10L 25/60; H04S 7/00

(52) U.S. Cl. CPC H04R 25/507; G10L 25/60; H04R 25/554; H04S 7/302; H04R 2225/43; H04S 2400/11; H04S 2420/01

(57) ABSTRACT

A system may include a first ear-worn device worn by a first wearer and a second ear-worn device worn by a second wearer, in which the first ear-worn device is configured to generate an audio signal based on sound from its environment, generate a speech portion of the audio signal using a neural network-based noise-reduction pipeline in the first ear-worn device, and transmit the speech portion of the audio signal to the second ear-worn device. The first ear-worn device may be configured to determine whether to transmit the speech portion of the audio signal to the second ear-worn device based on an own-voice heuristic. The second ear-worn device may be configured to generate an output audio signal by applying a first weight to the speech portion of the first ear-worn device's audio signal and a second weight to the speech portion of its own audio signal.

### BACKGROUND

### Field

The present disclosure relates to ear-worn devices. Some aspects relate to ear-worn devices with remote pairing to other ear-worn devices.

### Related Art

Ear-worn devices, such as hearing aids, may be used to help those who have trouble hearing to hear better. Typically, ear-worn devices amplify received sound. Some ear-worn devices may attempt to reduce noise in received sound.

### SUMMARY

People using ear-worn devices (e.g., hearing aids or cochlear implants) may tend to struggle to hear clearly in noisy environments. This may be because in a noisy environment, the speech of the target speaker is often at a similar or lower volume than the noise. Ear-worn devices may thus attempt to improve the signal to noise ratio of the amplified signal so that it is easier for the wearer to understand the target speech. There are a variety of techniques employed by ear-worn devices to accomplish this goal, including using speech enhancement algorithms, beamforming techniques, directional microphones, and other signal processing techniques. In some cases, ear-worn devices may use remote microphones. Remote microphones placed near a target sound source may have a much higher input signal-to-noise ratio (SNR) than the microphones on the ear-worn device of the wearer. This higher-SNR signal may be transmitted to the ear-worn device wirelessly and then played back for the wearer.

Typically, remote microphones take the form of an object that can be placed near or worn by a conversation partner. Examples include a lapel mic, a necklace, a pen (that can go in a breast pocket or on a table), or a table microphone. In some cases, smartphones can be used as remote microphones. Problems with remote microphones may include the following: 1. They typically cost additional money, because they require additional hardware for the manufacturers to support 2. They can be cumbersome to set up, and 3. They can be socially awkward, as the wearer must typically ask their conversation partner to accommodate the remote microphone in the right location.

The inventors have developed an alternative solution that may be used instead of or in conjunction with traditional remote microphones, namely using other ear-worn devices as remote microphones. In some embodiments, ear-worn device(s) may pair with other ear-worn device(s) and communicate wirelessly using low-latency radio communication between the devices (referred to herein as “paired mode”). This may be done, for example, using Bluetooth (e.g., Bluetooth 5.2) or a custom radio protocol.

This approach may offer numerous advantages. There may be no need to purchase or set up an additional accessory if the conversation partner is an ear-worn device wearer whose ear-worn device supports this feature. Because of the prevalence of hearing loss and the demographic concentration of ear-worn device wearers in the older population, ear-worn device wearers are frequently in communication with other ear-worn device wearers. Furthermore, ear-worn devices may generally be able to achieve a high starting SNR for the wearer's own voice.

### BRIEF DESCRIPTION OF DRAWINGS

FIG. 1 illustrates an ear-worn device, in accordance with certain embodiments described herein;

FIG. 2 illustrates a system of two ear-worn devices, in accordance with certain embodiments described herein;

FIG. 3 illustrates an option for how each of a wearer's two ear-worn devices may transmit audio to and receive audio from each of another wearer's two ear-worn devices, in accordance with certain embodiments described herein;

FIG. 4 illustrates an option for how each of a wearer's two ear-worn devices may transmit audio to and receive audio from each of another wearer's two ear-worn devices, in accordance with certain embodiments described herein;

FIG. 5 illustrates an option for how each of a wearer's two ear-worn devices may transmit audio to and receive audio from each of another wearer's two ear-worn devices, in accordance with certain embodiments described herein;

FIG. 6 illustrates a system for pairing two ear-worn devices, in accordance with certain embodiments described herein;

FIG. 7 illustrates the processing circuitry of FIG. 1 in more detail, in accordance with certain embodiments described herein;

FIG. 8 illustrates the noise reduction circuitry of FIG. 1 in more detail, in accordance with certain embodiments described herein;

FIG. 9 illustrates an example of mixing local and remote audio signals together, in accordance with certain embodiments described herein;

FIG. 10 illustrates an example timeline for an ear-worn device's operation when in paired mode, in accordance with certain embodiments described herein; and

FIG. 11 illustrates a hearing aid, in accordance with certain embodiments described herein.

### DETAILED DESCRIPTION

The aspects and embodiments described above, as well as additional aspects and embodiments, are described further below. These aspects and/or embodiments may be used individually, all together, or in any combination of two or more, as the disclosure is not limited in this respect.

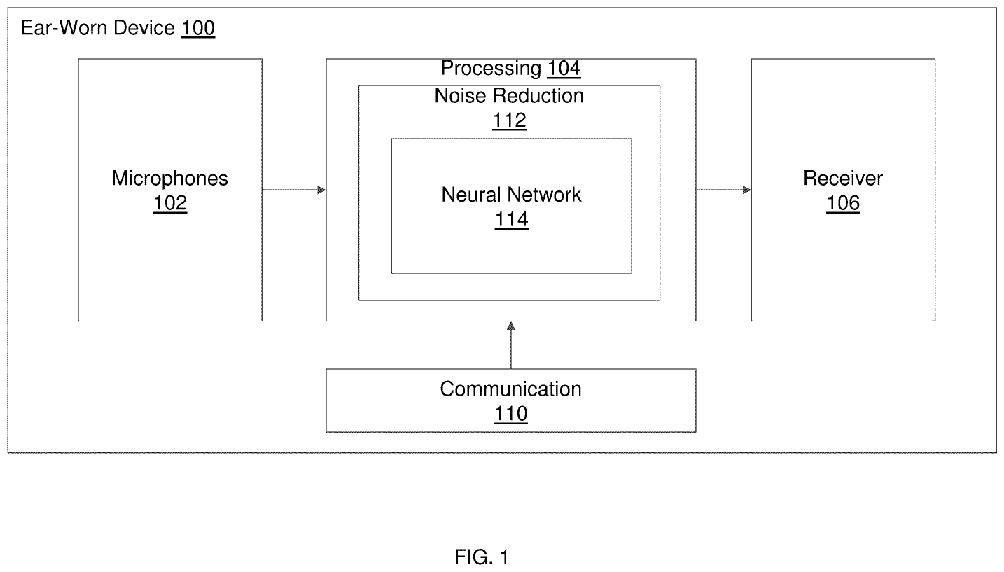

FIG. 1 illustrates an ear-worn device 100, in accordance with certain embodiments described herein. The ear-worn device 100 may be, for example, a hearing aid, a cochlear implant, or an earphone. The ear-worn device 100 includes microphones 102, processing circuitry 104, a receiver 106, and communication circuitry 110. The processing circuitry 104 includes noise reduction circuitry 112. The noise reduction circuitry 112 includes neural network circuitry 114. The neural network circuitry 114 may be configured to implement a neural network (or generally, one or more neural network layers).

The one or more microphones 102 may include one, two, or more than two (e.g., 2, 3, 4, or more) microphones. For example, the one or more microphones 102 may include two microphones, a front microphone that is closer to the front of the wearer of the ear-worn device 100 and a back microphone that is closer to the back of the wearer of the ear-worn device 100. As another example, the one or more microphones 102 may include more than two microphones in an array. Microphones in an array may be linked via wireless communication (e.g., the microphones may be disposed on two different ear-worn devices configured for binaural communication). The one or more microphones 102 may be configured to receive sound signals and to generate audio signals from the sound signals.

The processing circuitry 104 may be configured to process the signals from the microphones 102. Further description of the processing circuitry 104 will be provided below.

The receiver 106 may be configured to play back the output of the processing circuitry 104 as sound into the ear of the user. The receiver 106 may also be configured to implement digital-to-analog conversion prior to the playing back.

The communication circuitry 110 may be configured to facilitate communication between the ear-worn device 100 and other devices (e.g., another ear-worn device), for example over wireless communication links (e.g., Bluetooth or near-field magnetic induction (NFMI)). When the communication circuitry 110 is configured to facilitate NFMI communication, the communication circuitry 110 may include a magnetic induction transceiver and supporting control, audio processing, and power management circuitry. When the communication circuitry 110 is configured to facilitate Bluetooth communication, the communication circuitry 110 may include a transceiver (e.g., a 2.4 GHz transceiver) and supporting control, audio processing, and power management circuitry.

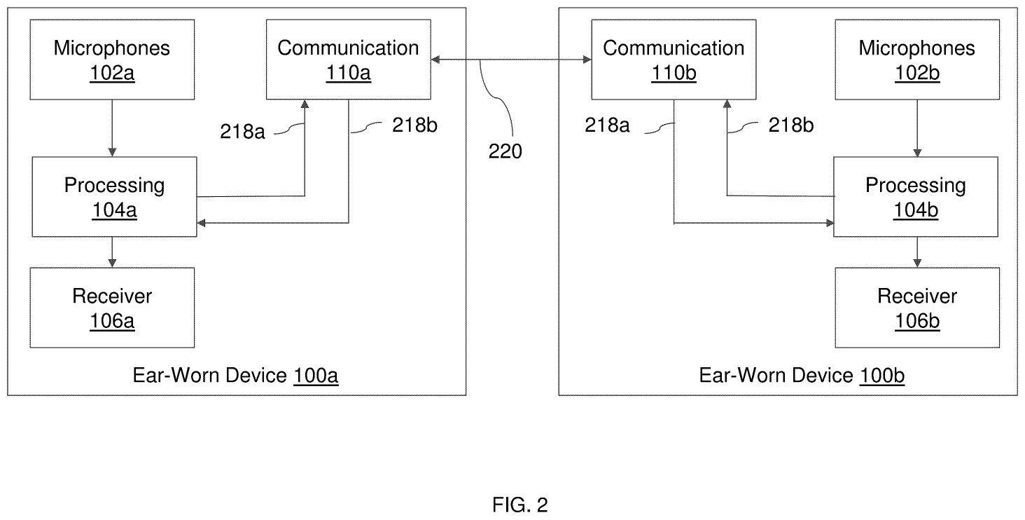

FIG. 2 illustrates a system of two ear-worn devices 100a and 100b, in accordance with certain embodiments described herein. In some embodiments, the ear-worn device 100a may be worn by one wearer and the ear-worn device 100b may be worn by another wearer. FIG. 2 illustrates a wireless communication link 220 (e.g., a Bluetooth or NFMI link) between the ear-worn device 100a and the ear-worn device 100b, facilitated by the communication circuitry 120a and the communication circuitry 120b. In other words, the communication circuitry 120a and the communication circuitry 120b may be configured to communicate over the wireless communication link 220. Thus, the ear-worn devices 100a and 10b may be configured to send data to each other over the wireless communication link 220.

As illustrated in FIG. 2, the ear-worn device 100a may be configured to send shared data 218a from the processing circuitry 104a to the communication circuitry 120a and the ear-worn device 100b may be configured to send shared data 218b from the processing circuitry 104b to the communication circuitry 120b. The communication circuitry 120a may be configured to receive the shared data 218b from the communication circuitry 120b over the wireless communication link 220, and the ear-worn device 100a may be configured to input the shared data 218b to the processing circuitry 104a. The communication circuitry 120b may be configured to receive the shared data 218a from the communication circuitry 120a over the wireless communication link 220, and the ear-worn device 100b may be configured to input the shared data 218a to the processing circuitry 104b.

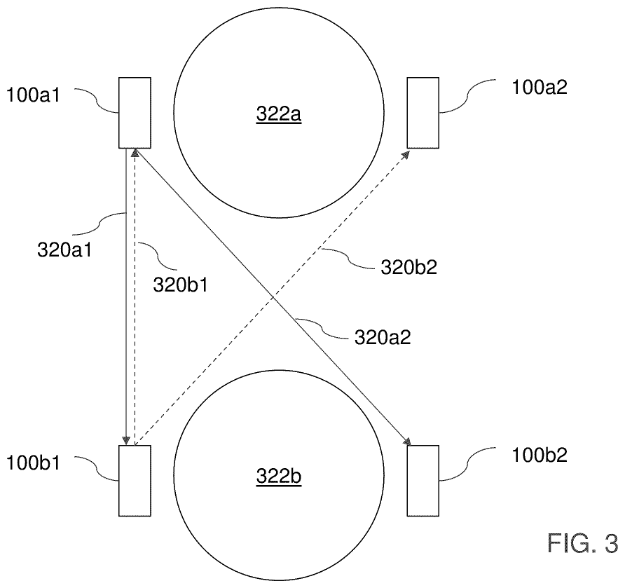

While FIG. 2 may illustrate one ear-worn device 100a of one wearer communicating with one ear-worn device 100b of another wearer, ear-worn device wearers typically have two ear-worn devices, one for each car. FIGS. 3-5 illustrate multiple options for how each of a wearer's two ear-worn devices may transmit audio to and receive audio from each of another wearer's two ear-worn devices, in accordance with certain embodiments described herein.

FIG. 3 illustrates a first wearer 322a and a second wearer 322b. The first wearer 322a is wearing a first ear-worn device 100a1 and a second ear-worn device 100a2. The second wearer 322b is wearing a first ear-worn device 100b1 and a second ear-worn device 100b2. The ear-worn devices 100a1, 100a2, 100b1, and 100b2 are configured to communicate with each other over wireless communication links 320a1, 320a2, 320b1, and 320b2, which may correspond to the wireless communication link 220. In more detail, the first ear-worn device 100a1 of the first wearer 322a is configured to transmit data to the first ear-worn device 100b1 of the second wearer 322b over the wireless communication link 320a1. The first ear-worn device 100a1 of the first wearer 322a is configured to transmit data to the second ear-worn device 100b2 of the second wearer 322b over the wireless communication link 320a2. The first ear-worn device 100b1 of the second wearer 322b is configured to transmit data to the first ear-worn device 100a1 of the first wearer 322a over the wireless communication link 320b1. The first ear-worn device 100b1 of the second wearer 322b is configured to transmit data to the second ear-worn device 100a2 of the first wearer 322a over the wireless communication link 320b2. Generally, each wearer may have one ear-worn device configured to transmit data to both ear-worn devices of the other wearer, and both ear-worn devices of each wearer may be configured to receive data from one of the other wearer's ear-worn devices. It should be appreciated that either of a wearer's ear-worn devices (i.e., right or left) may be configured to transmit data, and FIG. 3 should not be considered limiting in this respect.

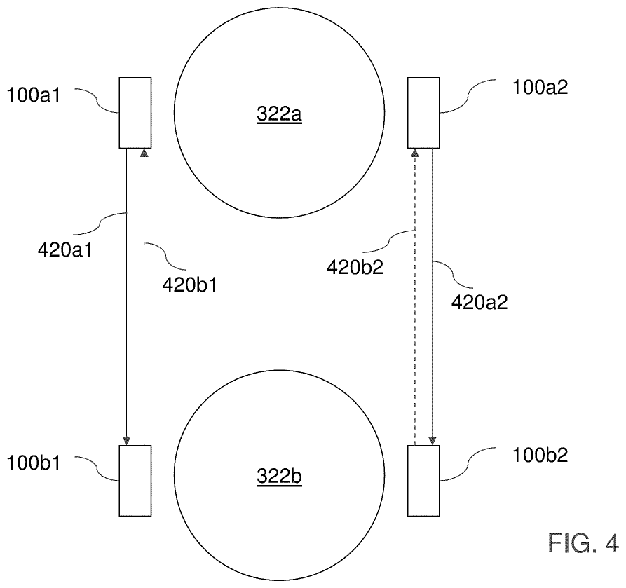

In FIG. 4, the ear-worn devices 100a1, 100a2, 100b1, and 100b2 are configured to communicate with each other over wireless communication links 420a1, 420a2, 420b1, and 420b2, which may correspond to the wireless communication link 220. In more detail, the first ear-worn device 100a1 of the first wearer 322a is configured to transmit data to the first ear-worn device 100b1 of the second wearer 322b over the wireless communication link 420a1. The second ear-worn device 100a2 of the first wearer 322a is configured to transmit data to the second ear-worn device 100b2 of the second wearer 322b over the wireless communication link 420a2. The first ear-worn device 100b1 of the second wearer 322b is configured to transmit data to the first ear-worn device 100a1 of the first wearer 322a over the wireless communication link 420b1. The second ear-worn device 100b1 of the second wearer 322b is configured to transmit data to the second ear-worn device 100a2 of the first wearer 322a over the wireless communication link 420b2. Generally, each of a wearer's ear-worn devices may be configured to transmit data to and receive data from one of the other wearer's ear-worn devices. It should be appreciated that the right ear-worn devices of both wearers may be configured to communicate, or the right ear-worn device of each wearer may be configured to communicate with the left ear-worn device of the other wearer, and FIG. 4 should not be considered limiting in this respect.

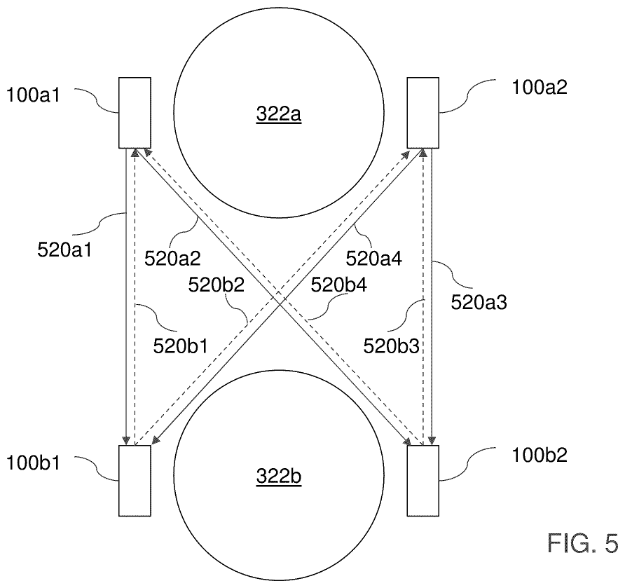

In FIG. 5, the ear-worn devices 100a1, 100a2, 100b1, and 100b2 are configured to communicate with each other over wireless communication links 520a1, 520a2, 520a3, 520a4, 520b1, 520b2, 520b3, and 520b4. which may correspond to the wireless communication link 220. In more detail, the first ear-worn device 100a1 of the first wearer 322a is configured to transmit data to the first ear-worn device 100b1 of the second wearer 322b over the wireless communication link 520a1 and to transmit data to the second ear-worn device 100b2 of the second wearer 322b over the wireless communication link 520a2. The second ear-worn device 100a2 of the first wearer 322a is configured to transmit data to the second ear-worn device 100b2 of the second wearer 322b over the wireless communication link 520a3 and to transmit data to the first ear-worn device 100b2 of the second wearer 322b over the wireless communication link 520a4. The first ear-worn device 100b1 of the second wearer 322b is configured to transmit data to the first ear-worn device 100a1 of the first wearer 322a over the wireless communication link 520b1 and to transmit data to the second ear-worn device 100a2 of the first wearer 322a over the wireless communication link 520b2. The second ear-worn device 100b1 of the second wearer 322b is configured to transmit data to the second ear-worn device 100a2 of the first wearer 322a over the wireless communication link 520b3 and to transmit data to the first ear-worn device 100a1 of the first wearer 322a over the wireless communication link 520b4. Generally, each of a wearer's ear-worn devices may be configured to transmit data to and receive data from each of the other wearer's ear-worn devices.

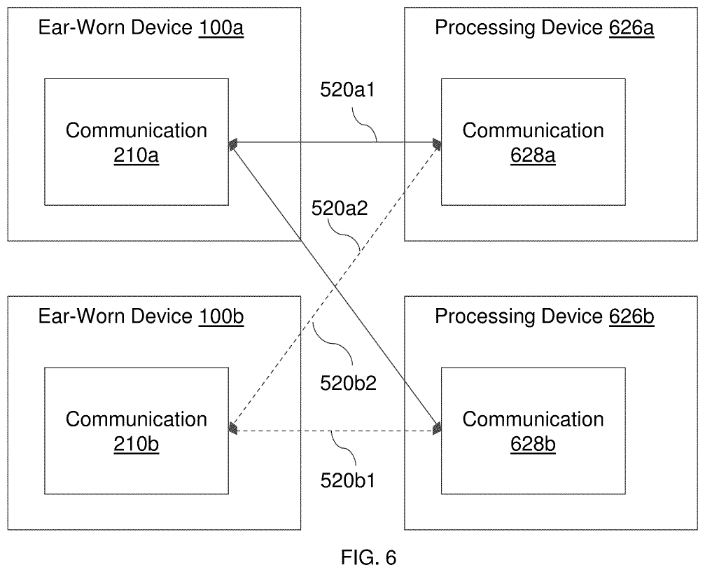

The communication links between ear-worn devices described herein may result from a pairing process. FIG. 6 illustrates a system for pairing two ear-worn devices, in accordance with certain embodiments described herein. The system includes the ear-worn device 100a, the ear-worn device 100b, a processing device 626a, and a processing device 626b. The processing device 626a includes communication circuitry 628a and the processing device 626b includes communication circuitry 628b. The communication circuitry 628a may be configured to facilitate communication between the processing device 626a and other devices (e.g., an ear-worn device), for example over wireless communication links (e.g., Bluetooth or near-field magnetic induction (NFMI)). The communication circuitry 628b may be configured to facilitate communication between the ear-worn device processing device 626b and other devices (e.g., an ear-worn device), for example over wireless communication links (e.g., Bluetooth or near-field magnetic induction (NFMI)). When the communication circuitry 628a and 628b are configured to facilitate NFMI communication, the communication circuitry 628a and 628b may include magnetic induction transceivers and supporting control, audio processing, and power management circuitry. When the communication circuitry 628a and 628b are configured to facilitate Bluetooth communication, the communication circuitry 628a and 628b may include transceivers (e.g., a 2.4 GHz transceiver) and supporting control, audio processing, and power management circuitry.

The processing device 626a is already in communication with the ear-worn device 100a over a communication link 520a1, and the processing device 626b is already in communication with the ear-worn device 100b over the communication link 520b1. The communication links 520a1 and 520b1 may have been established through pairing processes not described herein. The processing device 626a may be operated by the wearer of the ear-worn device 100a and the processing device 626b may be operated by the wearer of the ear-worn device 100b. The processing devices 626a and 626b may be, for example, smartphones or tablets. When the wearers of the ear-worn devices 100a and 100b desire to pair their ear-worn devices, the wearer of the ear-worn device 200a may cause the processing device 626a to transmit an inquiry for other devices over a particular frequency range, and the ear-worn device 100b may transmit a response back over that frequency range. The communication between these two devices is illustrated as 520a2. Similarly, the wearer of the ear-worn device 100b may cause the processing device 626b to transmit inquiries for other devices over a particular frequency range, and the ear-worn device 100a may transmit a response back over that frequency range. The communication between these two devices is illustrated as 520b2. Based on the responses, the processing device 626a may transmit information about the ear-worn device 100b to the ear-worn device 100a over the wireless communication link 520a1, and the processing device 626b may transmit information about the ear-worn device 100a to the ear-worn device 100b over the wireless communication link 520b1. Based on this information, the ear-worn devices 100a and 100b may establish a wireless communication link between each other (e.g., the wireless communication link 220). When the ear-worn devices 100a and 100b are in wireless communication with each other, they may be considered to be in paired mode. In some embodiments, the processing devices 626a and 626b may be configured to push notifications to their respective wearers when another ear-worn device is in range. In some embodiments, the processing devices 626a and 626b may be configured to cause their respective ear-worn devices to pair with other ear-worn devices when in range.

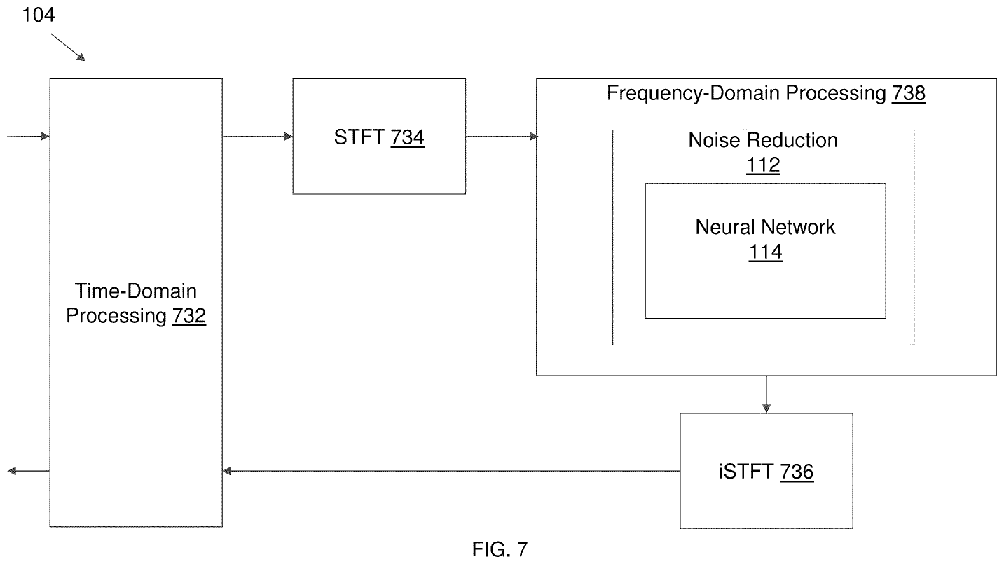

FIG. 7 illustrates the processing circuitry 104 of FIG. 1 in more detail, in accordance with certain embodiments described herein. The processing circuitry 104 includes time-domain processing circuitry 732, short-time Fourier transformation (STFT) circuitry 734, frequency-domain processing circuitry 738, and inverse STFT circuitry 736. The frequency-domain processing circuitry 738 includes the noise reduction circuitry 112. The noise reduction circuitry 112 includes the neural network circuitry 114. The neural network circuitry 114 may be configured to implement a neural network (or generally, one or more neural network layers).

The time-domain processing circuitry 732 may be configured to receive audio signals from the one or more microphones 102 (not illustrated in FIG. 7) and perform time-domain processing. For example, the time-domain processing may include input calibration and anti-feedback processing (although one or both of these may be performed by the frequency-domain processing circuitry 738 in some embodiments). The STFT circuitry 734 may be configured to convert short windows of time-domain signals into the frequency domain. The frequency-domain processing circuitry 738 may be configured to perform frequency-domain processing, including noise reduction (as performed by the noise reduction circuitry 112). As examples, the frequency-domain processing may also include wind reduction and wide dynamic range compression (WDRC) (although one or both of these may be performed by the time-domain processing circuitry 732 in some embodiments). The iSTFT circuitry 736 may be configured to convert audio signals from the frequency domain back to the time domain. The time-domain processing circuitry 732 may then be configured to perform further time-domain processing, such as output calibration, prior to generating an output audio signal (although output calibration may be performed by the frequency-domain processing circuitry 738 in some embodiments).

Returning to the noise reduction circuitry 112, in some embodiments the noise reduction circuitry 112 may be configured to perform background noise reduction. In some embodiments, the noise reduction circuitry 112 may be configured to perform spatial focusing. In some embodiments, the noise reduction circuitry 112 may be configured to perform background noise reduction and spatial focusing. The noise reduction circuitry 112 may be configured to use a neural network, implemented by the neural network circuitry 114, to perform the background noise reduction and/or spatial focusing. In particular, the neural network may be trained to generate one or more outputs, such as a mask, configured to generate audio signals having reduced background noise and/or spatial focus.

As described above, in some embodiments, an ear-worn device may be configured to convert its input audio signals from the time-domain into the frequency-domain using a short-time Fourier transform (STFT) prior to performing noise reduction. In some embodiments, when transmitting audio from one ear-worn device to another (e.g., as described with reference to FIG. 2), the ear-worn devices may be configured to ensure timing is such that data is transmitted as soon as processing of a window of data is complete. In some embodiments, the ear-worn devices may be configured to align the packet size of its transmitted audio with the STFT window size. This may allow the ear-worn devices to reuse as much of their noise reduction pipeline as possible. In other words, they may proceed all the way through the noise reduction pipeline and then transmit the noise-reduced audio to the receiving ear-worn device.

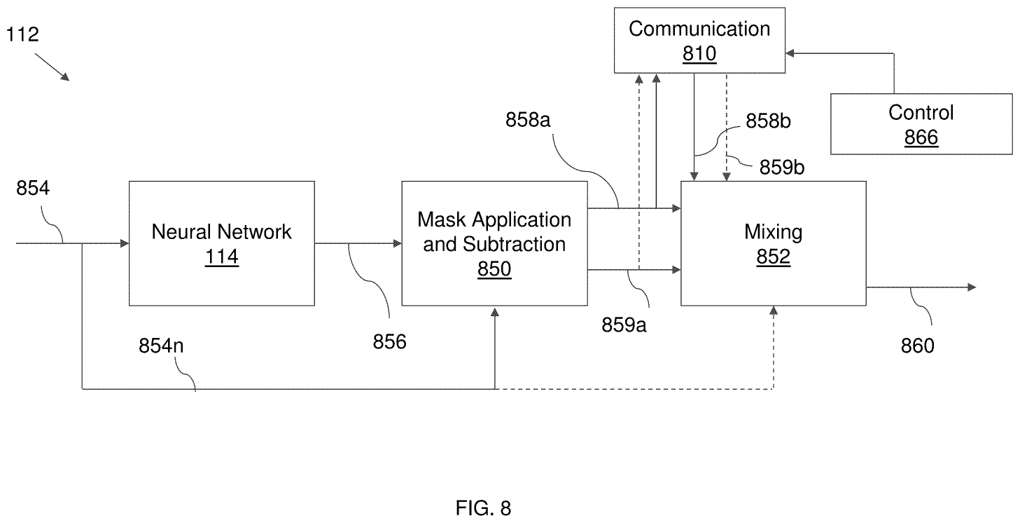

FIG. 8 illustrates the noise reduction circuitry 112 of FIG. 1 in more detail, in accordance with certain embodiments described herein. The noise reduction circuitry 112 includes the neural network circuitry 114, mask application and subtraction circuitry 850, mixing circuitry 852, control circuitry 866, and communication circuitry 910. Generally, the neural network circuitry 114 may be configured to receive one or more audio signals 854 and implement a neural network (or generally, one or more neural network layers) trained to perform noise reduction and/or spatial focusing based on the one or more audio signals 854.

Thus, in some embodiments, the neural network implemented by the neural network circuitry 114 may be trained to reduce noise. In such embodiments, one of the one or more neural network outputs 856 from the neural network circuitry 114 may be a version of the audio signal 854n (i.e., one of the one or more audio signals 854) that has less noise (or just speech), an output (e.g., a mask) configured to generate a version of the audio signal 854n that has less noise (or just speech), a version of the audio signal 854n that has less speech (or just noise), or an output (e.g., a mask) configured to generate a version of the audio signal 854n that has less speech (or just noise).

In some embodiments, the neural network implemented by the neural network circuitry 114 may be trained to perform spatial focusing. In such embodiments, one of the one or more neural network outputs 856 from the neural network circuitry 114 may be a spatially-focused version of the audio signal 854n, or an output (e.g., a mask) configured to generate the spatially-focused version of one of the audio signal 854n).

In some embodiments, the neural network implemented by the neural network circuitry 114 may be trained to both reduce noise and perform spatial focusing. In such embodiments, one of the one or more neural network outputs 856 from the neural network circuitry 114 may be a noise-reduced and spatially-focused version of the audio signal 854n, or an output (e.g., a mask) configured to generate the noise-reduced and spatially-focused version of the audio signal 854n. In some embodiments, one neural network layer may be trained to reduce noise, perform spatial focusing, or both reduce noise and perform spatial focusing. In some embodiments, multiple neural network layers may be trained to reduce noise, perform spatial focusing, or both reduce noise and perform spatial focusing. As described above, the neural network circuitry 114 may be trained to generate a mask configured to generate a noise-reduced and/or spatially-focused audio signal. In other words, the mask may be a noise-reducing mask, a spatially-focusing mask, or a noise-reducing and spatially-focusing mask.

This description may describe neural networks that are trained to perform a certain

action, or to generate an output for use in performing that action. As referred to herein, neural networks may be considered trained to perform a certain action if the neural networks perform that action themselves, or if they generate output for use in performing that action. Thus, it should be appreciated that neural networks may be considered trained to perform noise reduction even if the neural network itself does not generate a noise-reduced audio signal; a neural network that generates a mask (or generally, an output) configured to be used to generate a noise-reduced audio signal may still be considered trained to perform noise reduction. In some embodiments, the mask may be configured to isolate a speech portion of an input signal. In some embodiments, the mask may be configured to isolate a noise portion of an input signal. In some embodiments, the output may be the speech portion or the noise portion itself. In any such embodiments, (and as described further below), the resulting portion (speech or noise) may be used to generate an output signal having less noise than the input signal, and thus the one or more neural networks may be referred to as trained to perform noise reduction. It should also be appreciated that a neural network may be considered trained to perform spatial focusing even if the neural network itself does not generate a spatially-focused audio signal; a neural network that generates an output configured to be used to generate a spatially-focused audio signal may still be considered trained to perform spatial focusing. The output may be, as a non-limiting example, a mask configured to generate a spatially-focused audio signal.

Any neural networks described herein may be, for example, of the recurrent, vanilla/feedforward, convolutional, generative adversarial, attention (e.g. transformer), or graphical type. Generally, a neural network made up of such layers may include an input layer, a plurality of intermediate layers, and an output layer, and the layers may be made up of a plurality of neurons/nodes to which neural network weights may be applied.

Generally, the neural network circuitry 114 may be configured to receive one or more audio signals 854. In some embodiments, the one or more audio signals 854 may include one signal. In some embodiments, the one or more audio signals 854 may include two signals. In some embodiments, the one or more audio signals 854 may include three signals. In some embodiments, the one or more audio signals 854 may include four signals. In some embodiments, the one or more audio signals 854 may include more than four signals. In some embodiments, the one or more audio signals 854 may be in the frequency domain. In some embodiments, the one or more audio signals 854 may be in the time domain. In some embodiments, the neural network circuitry 114 may be configured to receive the one or more audio signals 854 together (i.e., not one after another). In some embodiments, the neural network circuitry 114 may be configured to process the one or more audio signals 854 together (i.e., not one after another).

In some embodiments, two or more of the audio signals 854 may each have a different beamformed directional pattern. For example, one or more of the audio signals 854 may be front-facing and one or more of the audio signals 854 may be rear-facing. Front-facing beamformed signals may generally attenuate signals coming from behind the wearer more than signals coming from in front of the wearer, and back-facing beamformed signals may generally attenuate signals coming from in front of the wearer more than signals coming from behind the wearer. Example directional patterns include cardioids, supercardioids, hypercardioids, and dipoles. In some embodiments, the neural network circuitry 114 may instead be configured to receive non-beamformed signals, or a mix of beamformed and non-beamformed signals.

Prior to neural network processing, the neural network circuitry 114 may be configured to perform pre-processing on the one or more audio signals 854 (in addition to the STFT performed by the STFT circuitry 734). In some embodiments, the pre-processing may include feature extraction, which may include performing certain mathematical transformations such as taking the magnitude. In some embodiments, the pre-processing circuitry may include normalization.

As described above, in some embodiments, the neural network circuitry 114 may be configured to implement a neural network trained to perform noise reduction and/or spatial focusing, such that the neural network circuitry 114 generates, based on the one or more audio signals 854, one or more neural network outputs 856. (For simplicity, this description may interchangeably describe receiving signals and generating outputs based on the signals as performed by neural network circuitry or by a neural network implemented by the neural network circuitry.) In some embodiments, the noise reduction circuitry 112 may be configured to generate, based on the one or more neural network outputs 856, at least one of a noise-reduced version of the audio signal 854n (which is one of the one or more audio signals 854), a spatially-focused version of the audio signal 854n, or a noise-reduced and spatially-focused version of the audio signal 854n. Following will be a description of various methods by which the noise reduction circuitry 112 may generate these signals based on the one or more neural network outputs 856.

In some embodiments, one of the one or more neural network outputs 856 may be a mask. A mask may be a real or complex mask that varies with frequency. Thus, when a mask is applied to (e.g., multiplied by, or added to) an audio signal (in the example of FIG. 8, the audio signal 854n), the mask may operate differently on different frequency components of the audio signal. In other words, the mask may cause different frequency components of the audio signal to be multiplied by different real or complex values. A real mask may modify just magnitude, while a complex mask may modify both magnitude and phase. When the one or more neural network outputs 856 include two masks, the two masks may be different.

With further regards to training, in some embodiments a neural network implemented by the neural network circuitry 114 may be trained to perform noise reduction. Training such neural network layers may include obtaining noisy speech audio signals and speech-isolated versions of the audio signals (i.e., with only the speech remaining). In some embodiments, masks that, when applied to the noisy speech audio signals, result in the speech-isolated audio signals may be determined. The training input data may be the noisy speech audio signals and the training output data may be the masks. The neural network may thereby learn how to output a speech-isolating mask for the audio signal 854n, such that when the mask is applied to (e.g., multiplied by or added to) the audio signal 854n, the resulting output audio signal is a speech-isolated version of the audio signal 854n. In some embodiments, masks that, when applied to the noisy speech audio signals, result in the noise-isolated audio signals may be determined. The training input data may be the noisy speech audio signal and the training output data may be the masks. The neural network layers may thereby learn how to output a noise-isolating mask for the audio signal 854n, such that when the mask is applied to (e.g., multiplied by or added to) the audio signal 854n, the resulting output audio signal is a noise-reduced version of the audio signal 854n. In embodiments in which the one or more neural networks are trained to output speech-isolated or noise-isolated signals themselves, the output training data may be the speech-isolated or noise-isolated signals themselves. Further description of neural networks trained to perform noise reduction may be found in U.S. Pat. No. 11,812,225, titled “Method, Apparatus and System for Neural Network Hearing Aid,” issued Nov. 7, 2023, which is incorporated by reference herein in its entirety.

In some embodiments, a neural network implemented by the neural network circuitry 114 may be trained to perform spatial focusing. Spatial focusing may include applying a spatial focusing pattern to an audio signal. A spatial focusing pattern may specify different weights as a function of direction-of-arrival (DOA) of sounds, where DOA may be defined relative to the wearer of the ear-worn device. In some embodiments, weights may be equal to 0, equal to 1, or between 0 and 1. In some embodiments, weights may be equal to or greater than 0. In some embodiments, weights may be greater than 0, less than 0, equal to zero, or complex numbers; a negative weight may flip phase by 180 degrees, while a complex weight may rotate the phase by some angle. Mapping weights to DOA may result in focusing, as higher weights may be applied to sounds originating from certain directions and lower weights may be applied to sounds originating from other directions. For training such neural network layers, a training audio signal may be formed from component audio signals originating from different DOAs. Multiple audio signals originating from multiple microphones may be generated from the training audio signal. When the neural network is trained to output a mask, a training mask may be determined such that, when the training mask is applied to one of the multiple audio signals, what remains is each component audio signal multiplied by a weight corresponding to the DOA from which it originated, and then summed together. The neural network may thereby learn how to output a mask based on multiple audio signals such that, when the mask is applied to (e.g., multiplied by or added to) to the audio signal 854n, the resulting output includes each component of the signal multiplied by a weight corresponding to the DOA from which it originated, and then summed together (e.g., resulting in a spatially-focused version of the audio signal 854n). In embodiments in which the one or more neural networks are trained to output spatially-focused signals, the output training data may be the spatially-focused signals themselves. Further description of neural networks for spatially focusing may be found in U.S. Pat. No. 11,937,047, entitled “Ear-Worn Device with Neural Network for Noise Reduction and/or Spatial Focusing Using Multiple Input Audio Signals” issued Mar. 19, 2024, which is incorporated by reference herein in its entirety.

In some embodiments, a neural network implemented by the neural network circuitry 114 may be trained to perform noise reduction and spatial focusing. For training such neural network layers, a training audio signal may be formed from component audio signals originating from different DOAs. Multiple audio signals originating from multiple microphones may be generated from the training audio signal. When the neural network is trained to output a mask, a training mask may be determined such that, when the training mask is applied to one of the multiple audio signals, what remains is the speech of each component audio signal multiplied by a weight corresponding to the DOA from which it originated, and then summed together. (As described above, training audio signals may include noisy speech audio signals and speech-isolated versions of the audio signals, i.e., with only the speech remaining.) The neural network may thereby learn how to output a mask based on the multiple audio signals such that, when the mask is applied to (e.g., multiplied by or added to) the audio signal 854n, the resulting output includes the speech of each component of the audio signal 854n multiplied by a weight corresponding to the DOA from which it originated, and then summed together, namely a noise-reduced and spatially-focused version of the speech portion of the audio signal 854n. In embodiments in which the one or more neural networks are trained to output noise-reduced and spatially-focused signals, the output training data may be the noise-reduced and spatially-focused signals themselves.

As described above, in some embodiments the neural network circuitry 114 may be configured to generate a mask that, when applied to (e.g., multiplied by or added to) the audio signal 854n, results in a certain other signal (e.g., a noise-reduced version of the audio signal 854n, a spatially-focused version of the audio signal 854n, or a noise-reduced and spatially-focused version of the audio signal 854). The mask may be one of the one or more neural network outputs 856. In some embodiments, the mask application and subtraction circuitry 850 in the noise reduction circuitry 112 may be configured to perform application of the mask to the audio signal 854n (e.g., using multiplication or addition).

In some embodiments, the mask application and subtraction circuitry 850 may be configured to obtain one or more signals by performing subtraction after the mask application. (However, in some embodiments, other operations, such as addition, may be used instead.) For example, consider that the mask application resulted in a speech portion 858a of the audio signal 854n. The mask application and subtraction circuitry 850 may be configured to obtain the noise portion 859a of the audio signal 854n by subtracting the speech portion from the audio signal 854n. As another example, consider that the mask application resulted in a noise portion 859a of the audio signal 854n. The mask application and subtraction circuitry 850 may be configured to obtain the speech portion 858a of the audio signal 854n by subtracting the noise portion from the audio signal 854n. As another example, consider that the mask application resulted in a speech portion of the audio signal 854n that is spatially-focused in a target direction (which may be referred to as a target speech signal). The mask application and subtraction circuitry 850 may be configured to obtain the speech portion of the audio signal 854n spatially-focused in non-target directions (which may be referred to as an interfering speech signal) by subtracting the target speech portion from the speech portion. As another example, consider that the mask application resulted in the interfering speech portion of the audio signal 854n. The mask application and subtraction circuitry 850 may be configured to obtain the target speech portion of the audio signal 854n by subtracting the interfering speech portion from the speech portion. Thus, the mask application and subtraction circuitry 850 may be configured to output one or more audio signals, generated as described above. FIG. 8 illustrates an example in which the one or more audio signals include the speech portion 858a of the audio signal 854n and the noise portion 859a of the audio signal 854n. The audio signal 854n may also be referred to as the local audio signal 854n. The speech portion 858a of the audio signal 854n may also be referred to as the local speech signal 858a or the speech portion 858a of the local audio signal 854n, and the noise portion 859a of the audio signal 854n may also be referred to as the local noise signal 859a or the speech portion 859a of the local audio signal 854n. “Local” with respect to a particular ear-worn device may mean that the signal was generated by that ear-worn device.

In some embodiments, the communication circuitry 810 may be configured to receive a speech signal 858b and optionally a noise signal 859b from another ear-worn device and provide the speech signal 858b and the noise signal 859b to the mixing circuitry 852. The speech signal 858b may also be referred to as the remote speech signal 858b or the speech portion 858b of the remote audio signal, and the noise signal 859b may also be referred to as the remote noise signal 859b or the noise portion 859b of the remote audio signal. “Remote” with respect to a particular ear-worn device may mean that the signal was generated by a different ear-worn device. The remote audio signal may be the analogue of the audio signal 854n on the other ear-worn device. The communication circuitry 810 may be configured to receive the remote speech signal 858b and optionally the remote noise signal 859b when the ear-worn device is in paired mode, under control of the control circuitry 866. Similarly, the communication circuitry 810 may be configured to transmit the local speech signal 858a and optionally the local noise signal 859a to the other ear-worn device when in paired mode, under control of the control circuitry 866. In some embodiments, stationary noise reduction may be performed on the speech signals 858a and 858b prior to sharing. The local speech signal 858a and optionally the local noise signal 859a may be an example of the shared data 218a and the remote speech signal 858b and optionally the remote noise signal 859b may be an example of the shared data 218b.

The control circuitry 866 may also be configured to control operation of the mixing circuitry 852 specifically for paired mode. The mixing circuitry 852 may be configured to mix two or more audio signals. Generally, the mixing circuitry 852 may be configured to mix a speech signal with an attenuated version of a noise signal. Mixing some noise back into the speech signal may help to reduce distortion and increase environmental awareness for the wearer of the ear-worn device. Thus, referring to a speech signal as “speech' and a noise signal as “noise,” the output of the mixing may generally be speech+x*noise, where x is a coefficient between 0 and 1. However, when in paired mode, there may be two speech signals and two noise signals. Thus, in the example of FIG. 8, the mixing circuitry 852 of the ear-worn device 100a may be configured to mix two or more of the local speech signal 858a, the local noise signal 859a, the remote speech signal 858b, and the remote noise signal 859b. Generally, the mixing circuitry 852 may be configured to mix one or more audio signals generated locally with one or more audio signals generated remotely. As referred to herein, mixing should be understood to mean any combination of different elements after application of weights to the different elements. Thus, the mixing circuitry 852 may be configured to apply different weights to signals (e.g., by multiplication) and combine the results together (e.g., by addition). The mixing performed by the mixing circuitry 852 may also be considered interpolation.

In some embodiments, the mixing circuitry 852 may be configured to mix the local audio signal 854n and the remote audio signal (the analogue of the local audio signal 854n on the remote ear-worn device). The mixing may be part of generating the output audio signal 860. In some embodiments, generating the output audio signal 860 may include applying a weight a to the remote speech signal 858b and a weight b to the local speech signal 858. In some embodiments, the remote speech weight is larger than the local speech weight (i.e., a is greater than b). In some embodiments, generating the output audio signal 860 may include excluding the local speech signal 858a from the output audio signal 860. In such embodiments, a weight of 1 may be applied to the remote speech signal 858b and a weight of 0 may be applied to the local speech signal 858a, or no explicit weight application may be performed. In some embodiments, generating the output audio signal 860 may include applying a weight c to the remote noise signal 859b and a weight d to the local noise signal 859a. In some embodiments, the remote noise weight is smaller than the local noise weight. In some embodiments, generating the output audio signal 860 may include excluding the remote noise signal 859b from the output audio signal 860. In such embodiments, a weight of 1 may be applied to the local noise signal 859a and a weight of 0 may be applied to the remote noise signal 859b, or no explicit weight application may be performed. Generally, once appropriate weights, if any, have been applied to the speech and noise signals, the formula speech+x*noise, where x is a coefficient between 0 and 1, may be applied. For example, if weights a, b, c, and d are applied to the remote speech signal 858b, the local speech signal 858a, the remote noise signal 859b, and the local noise signal 858b, respectively, then the output audio signal 860 from the noise reduction circuitry 112 may be [a*(remote speech)+b*(local speech)]+x*[c*(remote noise)+d*(local noise)]. As another example, if weights a and b are applied to the remote speech signal 858b and the local speech signal 858a, respectively, then the output audio signal 860 from the noise reduction circuitry 112 may be [a*(remote speech)+b*(local speech)]+x*[(local noise)]. In some embodiments, stationary noise reduction may be performed on the output audio signal 860, or a portion of it, in addition to neural network-based noise reduction. As will be described further, in some embodiments, the ear-worn devices may be configured to transmit the wearer's voice only when in paired mode. A non-limiting list of techniques for own-voice detection may be found below. In such embodiments, when an ear-worn device is receiving data from a paired ear-worn device, the receiving ear-worn device may be configured to mix the local and remote audio signals together such that the remote speech signal 858b is used exclusively (or, at least, weighted more than the local speech signal 858a) and the local noise signal 859a is used exclusively (or, at least, weighted more than the remote noise signal 859b). In some embodiments, an ear-worn device may be configured to perform a constant combination of the local and remote audio signals. In such embodiments, the local and remote audio signals may be time aligned, as described below. As the ear-worn device may be configured to exclude the remote noise signal 859 from its output, in some embodiments the remote noise signal 859 may not be transmitted to the ear-worn device, and/or the ear-worn device may be not be configured to apply any weight to it.

In some embodiments, an ear-worn device may be configured to mix the local and remote audio signals in a time-varying manner based on the quality of the signals. For example, the ear-worn device may be configured to determine the time-varying quality of the local audio signal 854n and the time-varying quality of the remote audio signal and modify the mixing accordingly. If the local quality switches from being less than the remote quality to being greater than the remote quality, the ear-worn device may be configured to switch the local speech weight from being smaller than the remote speech weight to being larger than the remote speech weight. If the remote quality switches from being less than the local quality to being greater than the local quality, the ear-worn device may be configured to switch the remote speech weight from being smaller than the local speech weight to being larger than the local speech weight. Thus, in some embodiments, an ear-worn device may be configured to a) always use the local noise signal 859a, and b) use the speech portion of whichever of the local audio signal 854n and the remote audio signal has the higher quality at a given time, and rapidly switch between the two speech signals based on the quality. In some embodiments, determining the quality of an audio signal may include determining the amplitude of the speech portion of the audio signal and/or determining the signal-to-noise ratio (SNR) of the audio signal. In embodiments in which an ear-worn device switches between the speech portions of the two audio signal, the ear-worn device may be configured to perform smoothing (i.e., ramp up the weight on the speech portion of one signal and ramp down the weight on the speech portion of the other signal over a time period) to prevent an audible discontinuity while switching. Thus, a switch may occur over a few milliseconds (e.g., over 1-40 milliseconds). In such embodiments, the two audio signals may be time aligned or not time-aligned (i.e., mixed latencies), as described below.

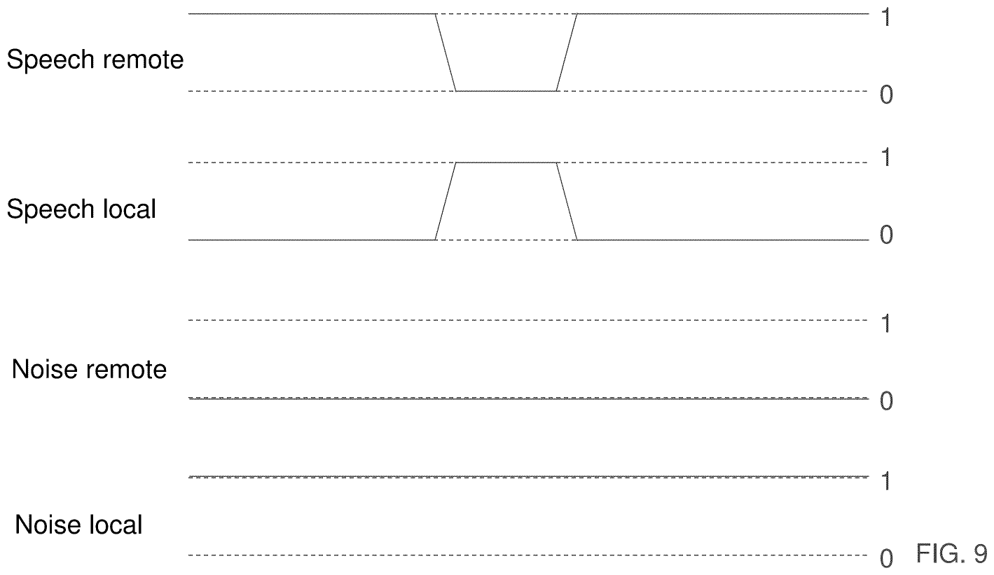

FIG. 9 illustrates an example of mixing local and remote audio signals together, in accordance with certain embodiments described herein. Each audio signal may contain a speech portion and a noise portion. In some embodiments, the speech and noise portions may be separated from each other using a neural network, as described herein. FIG. 9 illustrates the weight placed on each of the speech portions and noise portions of the local and remote audio signals. As illustrated, and as described previously, the hearing aid may switch between the local and remote speech portions, for example based on amplitude or SNR. As further illustrated, during switching the weights on the speech portions may ramp from 0 to 1 or from 1 to 0 rather than abruptly changing. The ramp may last, for example, for 1-40 milliseconds. In some embodiments, the local speech weight may be 1 minus the remote speech weight, and the local noise weight may be 1 minus the remote noise weight. In the example of FIG. 9, the local noise signal 859a is used exclusively and the remote noise portion 859b is not used. As described above, once the weights illustrated in FIG. 9 have been applied, then the formula speech+x*noise, where x is a coefficient between 0 and 1, may be applied. Thus, the output may be [a*(remote speech)+b*(local speech)]+x*[c*(remote noise)+d*(local noise)].

Regarding time alignment, in some embodiments the two audio signals may be time aligned. This may involve delaying each ear-worn device's local audio signal 854n to accommodate the additional latency of the remote audio signal. In some embodiments, Bluetooth wireless transmission may allow for alignment of the clocks of the paired devices. For example, two devices communicating using Bluetooth may be configured to negotiate a connection interval (n milliseconds) such that the two devices wake up every n seconds and exchange messages. Additionally, the two devices may agree on how long all the pre- and post-processing steps take. Based on this, the receiving device can know how long to delay its own audio signal in order to be synchronized with the transmitting device's audio signal. In some embodiments, the two audio signals may not be aligned, but instead signals with mixed latencies may be used.

Thus, in some embodiments, ear-worn devices may be configured to perform noise reduction to achieve improved audio quality. In some embodiments, during paired mode, the ear-worn devices may transmit noise-reduced audio signals to each other. Thus, in a system including a first ear-worn device worn by a first wearer and a second ear-worn device worn by a second wearer, the first ear-worn device may be configured to generate a first audio signal based on sound from the environment of the first ear-worn device, generate a speech portion of the first audio signal using a noise-reduction pipeline that includes a neural network, and when in paired mode, transmit the first audio signal to the second ear-worn device. Further description of neural network-based noise reduction may be found in U.S. Pat. No. 11,812,225, titled “Method, apparatus and system for neural network hearing aid,” and issued on Nov. 7, 2023, the content of which is incorporated by reference herein in its entirety. One advantage of this approach may be that the ear-worn devices may not need to change their normal neural network-based noise reduction. In other words, the noise-reduction pipeline may be the same in paired mode or in a non-paired mode. Any incremental latency may just be due to the wireless transmission. In some embodiments, the ear-worn devices may be configured to transmit something other than the noise-reduced audio signals to each other. For example, if a neural network running on an ear-worn device predicts a mask (e.g., a mask that may be used to separate speech from noise in an audio signal), the ear-worn device may be configured to transmit the mask to the other ear-worn device. The ear-worn device receiving the mask may be configured to apply the mask to its input audio signal. In some embodiments, each ear-worn device may be configured to isolate and transmit the respective wearer's voice but not other speakers' voices. A non-limiting list of techniques for own-voice detection may be found below.

The inventors have recognized that the frequency with which paired ear-worn devices send data back and forth may be a significant drain on their batteries. In some embodiments, an ear-worn device may determine whether to transmit its audio signal based on a heuristic performed on the audio signal. For example, the ear-worn device may only transmit its audio signal when it determines that its wearer is talking. Thus, the ear-worn device may be configured to detect when the audio signal contains the wearer's own voice and start transmitting its audio signal while the wearer is talking. The receiving ear-worn device may be configured to scan for transmitted signals constantly. A non-limiting list of techniques for own-voice detection may be found below.

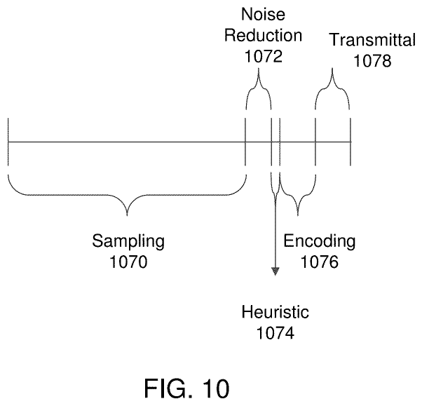

FIG. 10 illustrates an example timeline for an ear-worn device's operation when in paired mode, in accordance with certain embodiments described herein. During a sampling time window 1070, the ear-worn device may be configured to sample audio from the environment of the ear-worn device, thereby generating an audio signal. During a noise reduction time window 1072 subsequent to the sampling window 1072, the ear-worn device may be configured to perform noise reduction on the audio signal (e.g., using a neural network), thereby generating a speech portion of the audio signal. During a heuristic time window 1074 subsequent to the noise reduction time window 1072, the ear-worn device may be configured to determine a heuristic for the audio signal. The ear-worn device may be configured to determine whether to transmit the speech portion of the audio signal to a paired ear-worn device based on the heuristic. Based on determining to transmit the speech portion of the audio signal using the heuristic, the ear-worn device may be configured to encode the speech portion of the audio signal during an encoding time window 1076 subsequent to the heuristic window, and transmit the speech portion of the audio signal to the paired ear-worn device during a transmittal time window 1078 subsequent to the encoding time window 1076.

The above description has described own-voice detection in the context of 1. Only transmitting the wearer's own voice to the other ear-worn device and 2. Determining whether to transmit an audio signal based on analysis of the wearer's own voice. A non-limiting list of techniques for own-voice detection include: 1. A neural network trained to detect when the wearer of a ear-worn device is speaking 2. A neural network trained to detect voice signatures and use the voice signatures to specifically output the wearer's own voice. Further description of voice signatures may be found in U.S. Pat. No. 11,812,225 (referenced above) 3. Traditional beamforming techniques to isolate near-field voices coming from in front of the wearer 4. Bone conduction microphones on the receiver of the ear-worn device 5. A sensor on the ear-worn device that would detect the vibration created by talking 6. SNR estimation, in which the ear-worn device transmits whenever any voice signal is over a certain threshold. In some embodiments, when estimating SNR, the ear-worn device may be configured to take a fast-moving average of the speech portion of the audio signal and a slow-moving average of the noise portion of the audio signal to compute the SNR. This may enable the SNR to rise quickly when someone starts speaking, and enable the SNR to not drop during an impulse noise 6. A combination of the above.

In some embodiments, the receiving ear-worn device and/or the transmitting ear-worn device may be configured to use spatial audio techniques (e.g., by applying a head-related transfer function (HRTF) to the transmitted audio, or more specifically, to the speech portion of an audio signal) to maintain some semblance of spatialization in the remote voice when played by the ear-worn device receiving the audio signal.

The above description has referred to pairing, but it should be appreciated that the pairing may involve connecting just two wearers' ear-worn devices or connecting more than two wearers' ear-worn devices. In the latter case, the ear-worn devices may be in a broadcast mode in which any device with access may receive the broadcasting ear-worn device's signal. Various methods may be used to connect ear-worn devices. In some embodiments, a wearer may scan a QR code associated with another wearer's ear-worn devices using their phone or tablet. In some embodiments, a wearer may tap their phone or tablet on another wearer's ear-worn device storage case. In such embodiments, the case may contain a near-field communication (NFC) chip storing an address of the associated ear-worn devices. In some embodiments, one wearer may receive an invitation on their phone or tablet from another wearer's phone or tablet. In some embodiments, the pairing may be accomplished without a phone or tablet, for example by placing the ear-worn devices close together and resetting the ear-worn devices. The ear-worn devices may then use the signal strength at boot to determine that they should connect. In some embodiments, two wearers' ear-worn devices need not necessarily be explicitly paired, but a ear-worn device may be configured to broadcast its support for this feature, and when a supported ear-worn device gets within range, a connection is started between the two ear-worn devices automatically.

While the methods described above have focused on scenarios in which the remote device is an ear-worn device, it should be appreciated that the methods may also be applied to scenarios in which the remote device is not an ear-worn device, but a different device that has a microphone.

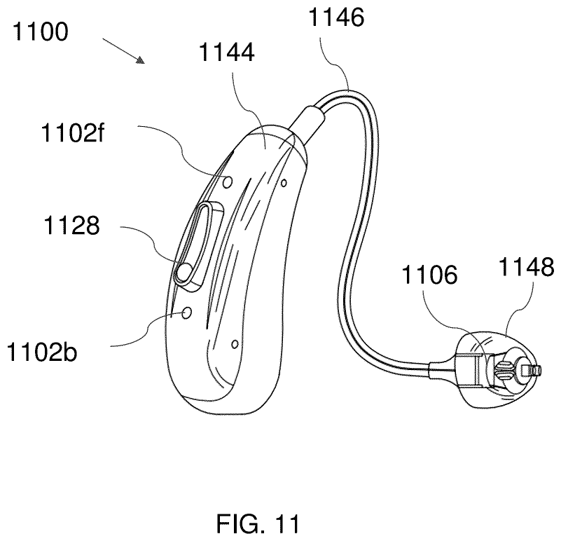

FIG. 11 illustrates a hearing aid 1100, in accordance with certain embodiments described herein. The hearing aid 1100 may be an example of any of the ear-worn devices or hearing aids described herein. The hearing aid 1100 is a receiver-in-canal (RIC) (also referred to as a receiver-in-the-ear (RITE)) type of hearing aid. However, any other type of hearing aid (e.g., behind-the-car, in-the-ear, in-the-canal, completely-in-canal, open fit, etc.) may also be used. The hearing aid 1100 includes a body 1144, a receiver wire 1146, a receiver 1106 (which may correspond to the receiver 106), and a dome 1148. The body 1144 is coupled to the receiver wire 1146 and the receiver wire 1146 is coupled to the receiver 1106. The dome 1148 is placed over the receiver 1106. The body 1144 includes a front microphone 1102f, a back microphone 1102b, and a user input device 1128. (The front microphone 1102f and the back microphone 1102b may correspond to the one or more microphones 102) The body 1144 additionally includes circuitry (e.g., any of the circuitry described above, aside from the receiver 1106) not illustrated in FIG. 11. When the hearing aid 1100 is worn, the front microphone 1102f may be closer to the front of the wearer and the back microphone 1102b may be closer to the back of the wearer. The front microphone 1102f and the back microphone 1102b may be configured to receive sound signals and generate audio signals based on the sound signals. Any of the microphones described herein may be the front microphone 1102f and/or the back microphone 1102b of the hearing aid 1100. The user input device 1128 (which may correspond to the user input device 128) may be configured to control certain functions of the hearing aid 1100, such as switching modes.

The receiver wire 1146 may be configured to transmit audio signals from the body 1144 to the receiver 1106. The receiver 1106 may be configured to receive audio signals (i.e., those audio signals generated by the body 1144 and transmitted by the receiver wire 1146) and generate sound signals based on the audio signals. The dome 1148 may be configured to fit tightly inside the wearer's ear and direct the sound signal produced by the receiver 1106 into the ear canal of the wearer.

In some embodiments, the length of the body 1144 may be equal to 2 cm, equal to 5 cm, or between 2 and 5 cm in length. In some embodiments, the weight of the hearing aid 1100 may be less than 4.5 grams. In some embodiments, the spacing between the microphones may be equal to 5 mm, equal to 12 mm, or between 5 and 12 mm. In some embodiments, the body 1144 may include a battery (not visible in FIG. 11), such as a lithium ion rechargeable coin cell battery.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. A system, comprising:
a first ear-worn device worn by a first wearer; and
a second ear-worn device worn by a second wearer;
wherein:
the first ear-worn device is configured to:
generate a first audio signal based on sound from an environment of the first ear-worn device;
generate a speech portion of the first audio signal using a noise-reduction pipeline in the first ear-worn device, wherein the noise-reduction pipeline comprises a neural network; and
transmit the speech portion of the first audio signal to the second ear-worn device.

2. The system of claim 1, wherein:
the first ear-worn device is configured to transmit the speech portion of the first audio signal to the second ear-worn device when in a paired mode; and
the noise-reduction pipeline comprises a same pipeline used by the first ear-worn device when in the paired mode or in a non-paired mode.

3. The system of claim 1, wherein:
the second ear-worn device is configured to:
generate a second audio signal based on sound from an environment of the second ear-worn device;
generate a speech portion of the second audio signal; and
generate an output audio signal by applying a first weight to the speech portion of the first audio signal and a second weight to the speech portion of the second audio signal.

4. The system of claim 3, wherein the first weight is larger than the second weight.

5. The system of claim 3, wherein the first weight is 1 and the second weight is 0.

6. The system of claim 3, wherein generating the output audio signal further includes excluding the speech portion of the second audio signal from the output audio signal.

7. The system of claim 3, wherein generating the output audio signal further includes applying a third weight to a noise portion of the first audio signal and a fourth weight to a noise portion of the second audio signal.

8. The system of claim 7, wherein the fourth weight is larger than the third weight.

9. The system of claim 7, wherein the fourth weight is 1 and the third weight is 0.

10. The system of claim 3, wherein generating the output audio signal further includes excluding a noise portion of the first audio signal from the output audio signal.

11. The system of claim 3, wherein the second ear-worn device is configured, when generating the output signal, to:
determine a first quality of the first audio signal and a second quality of the second audio signal;
switch the second weight from being smaller than the first weight to being larger than the first weight if the second quality switches from being less than the first quality to being greater than the first quality; and
switch the first weight from being smaller than the second weight to being larger than the second weight if the first quality switches from being less than the second quality to being greater than the second quality.

12. The system of claim 11, wherein the second ear-worn device is configured, when switching the second weight from being smaller than the first weight to being larger than the first weight, to ramp down the first weight and ramp up the second weight over a time period.

13. The system of claim 12, wherein the time period comprises 1-40 milliseconds.

14. The system of claim 11, wherein the second ear-worn device is configured, when determining the first quality of the first audio signal and the second quality of the second audio signal, to determine:
a first amplitude of the speech portion of the first audio signal and a second amplitude of the speech portion of the second audio signal; and/or
a first signal-to-noise ratio (SNR) of the first audio signal and a second SNR of the second audio signal.

15. The system of claim 1, wherein the first ear-worn device is configured to isolate the first wearer's voice such that the speech portion of the first audio signal comprises the first wearer's voice but not other speakers' voices.

16. The system of claim 1, wherein the first audio signal and the second audio signal are time- aligned.

17. The system of claim 1, wherein the first audio signal and the second audio signal are not time-aligned.

18. The system of claim 1, wherein the first ear-worn device is configured to pair to the second ear-worn device by:
the first wearer scanning a QR code with their phone or tablet;
the first wearer tapping their phone or tablet on a storage case for the second ear-worn device;
the first wearer receiving an invitation on their phone or tablet from a phone or tablet of the second wearer; or
placing the first ear-worn device and the second ear-worn device near to each other and resetting them.

19. The system of claim 1, wherein the first ear-worn device and/or the second ear-worn device is configured to apply a head-related transfer function to the speech portion of the first audio signal.

20. A system, comprising:
a first ear-worn device worn by a first wearer;
a second ear-worn device worn by a second wearer;
wherein:
the first ear-worn device is configured to:
sample audio from an environment of the first ear-worn device during a first time window, thereby generating an audio signal
perform noise reduction on the audio signal during a second time window subsequent to the first time window, thereby generating a speech portion of the audio signal;
determine a heuristic for the audio signal based on own-voice detection of the first wearer during a third time window subsequent to the second time window;
determine whether to transmit the speech portion of the audio signal to the second ear-worn device based on the heuristic; and
based on determining to transmit the audio signal to the second ear-worn device using the heuristic:
encode the speech portion of audio signal during a fourth time window subsequent to the third time window; and
transmit the speech portion of the audio signal to the second ear-worn device during a fifth time window subsequent to the fourth time window.

21. The system of claim 20, wherein the first ear-worn device is configured to use a noise-reduction pipeline comprising a neural network for generating the speech portion of the audio signal.

22. The system of claim 20, wherein:
the first ear-worn device is configured to transmit the speech portion of the audio signal to the second ear-worn device when in a paired mode; and
the noise-reduction pipeline comprises a same pipeline used by the first ear-worn device when in the paired mode or in a non-paired mode.

23. The system of claim 20, wherein the first ear-worn device is configured to isolate the first wearer's voice such that the speech portion of the audio signal comprises the first wearer's voice but not other speakers' voices.

24. The system of claim 20, wherein the first ear-worn device is configured to pair to the second ear-worn device by:
the first wearer scanning a QR code with their phone or tablet;
the first wearer tapping their phone or tablet on a storage case for the second ear-worn device;
the first wearer receiving an invitation on their phone or tablet from a phone or tablet of the second wearer; or
placing the first ear-worn device and the second ear-worn device near to each other and resetting them.

25. The system of claim 20, wherein the first ear-worn device and/or the second ear-worn device is configured to apply a head-related transfer function to the speech portion of the audio signal.
